(19) United States
(12) Patent Application Publication
(10) Pub. No.: US 2016/0255642 A1
(43) Pub. Date: Sep. 1, 2016

(54) METHODS AND APPARATUS FOR WAVEFORM PROTECTION IN A MIXED WIRELESS COMMUNICATION SYSTEM

(71) Applicant: QUALCOMM Incorporated, San Diego, CA (US)

(72) Inventors: Rahul Malik, San Diego, CA (US); Hemanth Sampath, San Diego, CA (US)

(21) Appl. No.: 15/051,457

(22) Filed: Feb. 23, 2016

Related U.S. Application Data
(60) Provisional application No. 62/126,433, filed on Feb. 27, 2015.
(60) Provisional application No. 62/126,434, filed on Feb. 27, 2015.
(60) Provisional application No. 62/126,427, filed on Feb. 27, 2015.
(60) Provisional application No. 62/126,436, filed on Feb. 27, 2015.
(60) Provisional application No. 62/126,431, filed on Feb. 27, 2015.

(51) Int. Cl. H04W 72/12; H04W 74/04

(52) U.S. Cl. CPC H04W 72/1215; H04W 74/04

(57) ABSTRACT

Certain aspects of the present disclosure relate to a methods and apparatus for wireless communication. In one aspect, a method a method of communication over a wireless medium. The method includes transmitting, from a first wireless device, a first communication reserving access to the wireless medium during an indicated first time period. The first communication includes a contention-based transmission. The method further includes transmitting, during the first time period, a second communication reserving access to the wireless medium during an indicated second time period at least partially overlapping the first. The second communication includes a scheduled transmission. The method further includes transmitting or receiving a long term evolution unlicensed (LTE-U) transmission during the second time period.

### PRIORITY CLAIM

This application claims the benefit of U.S. Provisional Application No. 62/126,433, filed Feb. 27, 2015; U.S. Provisional Application No. 62/126,434, filed Feb. 27, 2015; U.S. Provisional Application No. 62/126,427, filed Feb. 27, 2015; U.S. Provisional Application No. 62/126,436, filed Feb. 27, 2015; and U.S. Provisional Application No. 62/126,431, filed Feb. 27, 2015; each of which is hereby incorporated herein by reference in its entirety.

### FIELD

Certain aspects of the present disclosure generally relate to wireless communications, and more particularly, to methods and apparatus for waveform protection in a mixed wireless communication system.

### BACKGROUND

For increasing volume and complexity of information communicated wirelessly between multiple devices in a wireless communication system, the requirement for managing a level of acceptable interference continues to increase. Such devices may operate in close proximity to one another while operating over a common frequency spectrum in accordance with different communication standards. Two of such systems standards are commonly known as long-term evolution (LTE) and wireless local area network (WLAN). Use of a common frequency by different devices inherently creates the possibility of experiencing interference while such devices are accessing the communication resources. Certain governmental regulatory agency makes spectrum available for wireless services, including licensed and unlicensed spectrums. Generally, wireless communications over the licensed frequencies are limited to one or more particular use and location. The licensed frequency spectrum has generally been provided for Cellular Market Areas (CMAs). The frequency spectrum designated as “unlicensed” or “licensed-exempt,” allows the users to freely operate wireless devices while complying with certain technical requirements, including transmission power limits. Users of the unlicensed frequency spectrum do not have exclusive use of the spectrum and are subject to interference by other users.

Generally, the particulars of the system protocol for operating in the licensed and unlicensed frequency spectrums may be different. The LTE standard allows LTE devices to operate in both licensed and unlicensed frequency spectrums. The WLAN devices may also be operating in the same unlicensed frequency spectrum. The LTE devices operating in the unlicensed frequency spectrum are generally known as LTE-U devices. LTE-U and WLAN devices may utilize a common frequency spectrum at essentially the same time or overlapping time periods. To reduce and possibly avoid a level of interference experienced by LTE-U and WLAN devices operating in a common unlicensed frequency spectrum, there is a need for controlling and managing use of the wireless communication resources.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a method of communication over a wireless medium. The method includes transmitting, from a first wireless device, a first communication reserving access to the wireless medium during an indicated first time period. The first communication includes a contention-based transmission. The method further includes transmitting, during the first time period, a second communication reserving access to the wireless medium during an indicated second time period at least partially overlapping the first. The second communication includes a scheduled transmission. The method further includes transmitting or receiving a long term evolution unlicensed (LTE-U) transmission during the second time period.

In various embodiments, the first time period includes a time of transmission of the LTE-U transmission. In various embodiments, the method can further include transmitting, after the LTE-U transmission, a third communication canceling reservation of access to the wireless medium by the first and second communications, wherein the third communication includes a scheduled transmission. In various embodiments, the third communication includes a contention-free period end frame.

In various embodiments, the third communication can be same as a fifth communication transmitted by another AP. In various embodiments, the first time period includes a time of transmission of the third communication. In various embodiments, transmission of the third communication can be synchronized with transmission from at least one other wireless device. In various embodiments, the second communication can be the same as a fourth communication, transmitted simultaneously by another access point.

In various embodiments, the method can further include transmitting one or more additional communications reserving access to the wireless medium during the LTE-U transmission. In various embodiments, the additional communications reserve access to the wireless medium for overlapping time periods. In various embodiments, the first wireless device includes a long term evolution unlicensed (LTE-U) device and the first and second communications include wireless local area network (WLAN) communications.

In various embodiments, the first wireless device includes an 802.11ax device and the first and second communications, and a third communication, include 802.11a communications. In various embodiments, the first communication includes a clear-to-send packet. In various embodiments, the second communication includes a clear-to-send packet.

Another aspect provides an apparatus configured to communicate over a wireless medium. The apparatus includes a processor configured to generate a first communication reserving access to the wireless medium during an indicated first time period. The first communication includes a contention-based transmission. The processor is further configured to generate, for transmission during the first time period, a second communication reserving access to the wireless medium during an indicated second time period at least partially overlapping the first. The second communication includes a scheduled transmission. The apparatus further includes a first transmitter configured to transmit the first and second communications. The apparatus further includes a transmitter or receiver configured to transmit or receive a long term evolution unlicensed (LTE-U) transmission during the second time period.

In various embodiments, the first time period includes a time of transmission of the LTE-U transmission. In various embodiments, the processor can be further configured to generate, for transmission after the LTE-U transmission, a third communication canceling reservation of access to the wireless medium by the first and second communications, wherein the third communication includes a scheduled transmission. In various embodiments, the third communication includes a contention-free period end frame.

In various embodiments, the third communication can be same as a fifth communication transmitted by another AP. In various embodiments, the first time period includes a time of transmission of the third communication. In various embodiments, transmission of the third communication can be synchronized with transmission from at least one other wireless device. In various embodiments, the second communication can be the same as a fourth communication, transmitted simultaneously by another access point.

In various embodiments, the processor can be further configured to generate one or more additional communications reserving access to the wireless medium during the LTE-U transmission. In various embodiments, the additional communications reserve access to the wireless medium for overlapping time periods. In various embodiments, the apparatus includes a long term evolution unlicensed (LTE-U) device and the first and second communications include wireless local area network (WLAN) communications.

In various embodiments, the apparatus includes an 802.11ax device and the first and second communications, and a third communication, include 802.11a communications. In various embodiments, the first communication includes a clear-to-send packet. In various embodiments, the second communication includes a clear-to-send packet.

Another aspect provides another apparatus for communication over a wireless medium. The apparatus includes means for transmitting a first communication reserving access to the wireless medium during an indicated first time period. The first communication includes a contention-based transmission. The apparatus further includes means for transmitting, during the first time period, a second communication reserving access to the wireless medium during an indicated second time period at least partially overlapping the first. The second communication includes a scheduled transmission. The apparatus further includes means for transmitting or receiving a long term evolution unlicensed (LTE-U) transmission during the second time period.

In various embodiments, the first time period includes a time of transmission of the LTE-U transmission. In various embodiments, the apparatus can further include means for transmitting, after the LTE-U transmission, a third communication canceling reservation of access to the wireless medium by the first and second communications, wherein the third communication includes a scheduled transmission. In various embodiments, the third communication includes a contention-free period end frame.

In various embodiments, the third communication can be same as a fifth communication transmitted by another AP. In various embodiments, the first time period includes a time of transmission of the third communication. In various embodiments, transmission of the third communication can be synchronized with transmission from at least one other wireless device. In various embodiments, the second communication can be the same as a fourth communication, transmitted simultaneously by another access point.

In various embodiments, the apparatus can further include means for transmitting one or more additional communications reserving access to the wireless medium during the LTE-U transmission. In various embodiments, the additional communications reserve access to the wireless medium for overlapping time periods. In various embodiments, the apparatus includes a long term evolution unlicensed (LTE-U) device and the first and second communications include wireless local area network (WLAN) communications.

In various embodiments, apparatus includes an 802.11ax device and the first and second communications, and a third communication, include 802.11a communications. In various embodiments, the first communication includes a clear-to-send packet. In various embodiments, the second communication includes a clear-to-send packet. In various embodiments, the third communication includes a CF-End Frame.

Another aspect provides a non-transitory computer-readable medium. The medium includes code that, when executed, causes an apparatus to transmit a first communication reserving access to the wireless medium during an indicated first time period. The first communication includes a contention-based transmission. The medium further includes code that, when executed, causes the apparatus to transmit, during the first time period, a second communication reserving access to the wireless medium during an indicated second time period at least partially overlapping the first. The second communication includes a scheduled transmission. The medium further includes code that, when executed, causes the apparatus to transmit or receiving a long term evolution unlicensed (LTE-U) transmission during the second time period.

In various embodiments, the first time period includes a time of transmission of the LTE-U transmission. In various embodiments, the medium can further include code that, when executed, causes the apparatus to transmit, after the LTE-U transmission, a third communication canceling reservation of access to the wireless medium by the first and second communications, wherein the third communication includes a scheduled transmission. In various embodiments, the third communication includes a contention-free period end frame.

In various embodiments, the third communication can be same as a fifth communication transmitted by another AP. In various embodiments, the first time period includes a time of transmission of the third communication. In various embodiments, transmission of the third communication can be synchronized with transmission from at least one other wireless device. In various embodiments, the second communication can be the same as a fourth communication, transmitted simultaneously by another access point.

In various embodiments, the medium can further include code that, when executed, causes the apparatus to transmit one or more additional communications reserving access to the wireless medium during the LTE-U transmission. In various embodiments, the additional communications reserve access to the wireless medium for overlapping time periods. In various embodiments, the apparatus includes a long term evolution unlicensed (LTE-U) device and the first and second communications include wireless local area network (WLAN) communications.

In various embodiments, the apparatus includes an 802.11ax device and the first and second communications, and a third communication, include 802.11a communications. In various embodiments, the first communication includes a clear-to-send packet. In various embodiments, the second communication includes a clear-to-send packet.

### BRIEF DESCRIPTION OF THE DRAWINGS

FIG. 1 illustrates an example of a wireless communication system in which aspects of the present disclosure may be employed.

FIG. 2 illustrates various components that may be utilized in a wireless device that may be employed within the wireless communication system of FIG. 1.

FIG. 3 illustrates a time sequence diagram of exemplary communications between LTE and WLAN devices, according to one embodiment.

FIG. 4 illustrates a time sequence diagram of exemplary communications between LTE and WLAN devices, according to another embodiment.

FIG. 5 illustrates a time sequence diagram of exemplary communications between LTE and WLAN devices, according to another embodiment.

FIG. 6 illustrates a time sequence diagram of exemplary communications between LTE and WLAN devices, according to another embodiment.

FIG. 7 illustrates time sequence diagrams of exemplary communications between LTE and WLAN devices, according to various embodiments.

FIG. 8 shows a flowchart for an example method of wireless communication that can be employed within the wireless communication system of FIG. 1.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently or combined with any other aspect of the disclosure. In addition, the scope is intended to cover such an apparatus or method which is practiced using other structure and functionality as set forth herein. It should be understood that any aspect disclosed herein may be embodied by one or more elements of a claim.

Although particular aspects are described herein, variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description. The detailed description and drawings are merely illustrative of the disclosure rather than limiting, the scope of the disclosure being defined by the appended claims and equivalents thereof.

The word “exemplary” is used herein to mean “serving as an example, instance, or illustration.” Any implementation described herein as “exemplary” is not necessarily to be construed as preferred or advantageous over other implementations. The following description is presented to enable any person skilled in the art to make and use the embodiments described herein. Details are set forth in the following description for purpose of explanation. In other instances, well-known structures and processes are not elaborated in order not to obscure the description of the disclosed embodiments with unnecessary details. Thus, the present application is not intended to be limited by the implementations shown, but is to be accorded with the broad scope consistent with the principles and features disclosed herein.

A WLAN device as described herein may use the protocols described in any of the 802.11 family of standards, such as 802.11a, 802.11ah, 802.11ac, 802.11n, 802.11g, 802.11b, and others. The WLAN device may be an access point (“AP”), or a station (“STA”). In general, an AP serves as a hub or a base station for the STAs in the communication network. An STA may be a laptop computer, a personal digital assistant (PDA), a mobile phone, etc. In general, an STA wirelessly connects to an AP via an IEEE 802.11 protocol communication link to have, for example, a wireless connectivity to the Internet, other devices and other networks. An STA may also operate as an AP.

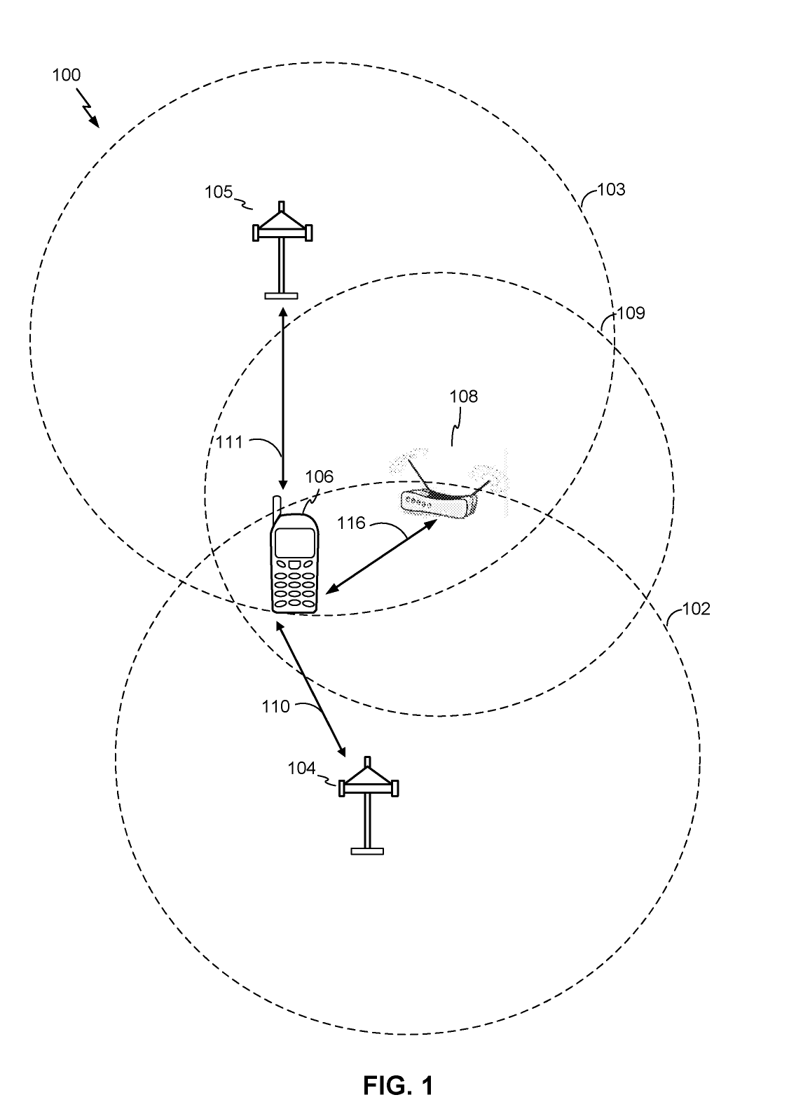

FIG. 1 illustrates an example of a wireless communication system 100 that may be incorporating various aspects of the present disclosure. Wireless communication system 100 may include an STA 106, base stations (BS) 104 and 105, and an AP 108. The BS 104 may provide wireless communication coverage in a coverage area 102. The BS 104 may provide wireless communication coverage in a coverage area 103. The AP 108 may provide wireless communication coverage in a basic service area (BSA) 109. The wireless communications in coverage area 102 and BSA 109 may include communications in an unlicensed frequency spectrum. A wireless communication connectivity service in accordance with LTE-U protocols may be provided by BS 104. Providing such a service includes at least transmission of LTE-U communications (e.g., data packets). In accordance with an embodiment, WLAN communications may also be transmitted by BS 104, for example, for data communications or to protect the LTE-U communications. Therefore, in accordance with an embodiment, a wireless communication link 110 between BS 104 and STA 106 may include transmission and reception of data packets in accordance with LTE-U and WLAN protocols. Similarly, a wireless communication link 111 between BS 105 and STA 106 may include transmission and reception of data packets in accordance with LTE-U and WLAN protocols. The AP 108 may communicate with STA 106 over a wireless communication link 116 in accordance with WLAN protocol protocols in the unlicensed frequency spectrum. As such, wireless communication link 110 and wireless communication link 116 may occur over a common unlicensed frequency spectrum at the same time or overlapping time periods.

Embodiments described herein are particularly related to coexisting operations of LTE-U and WLAN devices using common communication resources (e.g., frequency spectrum and transmission time). Generally, wireless communication system 100 includes many different devices aspects of which may operate over a common unlicensed frequency spectrum. Some of these devices may be operating in accordance with WLAN protocols (WLAN devices) and while others in accordance with the LTE-U protocol (LTE-U devices). The LTE-U and WLAN wireless communication links with such devices may occur at essentially the same time or overlapping time periods. Sharing communication resources such as the frequency spectrum and the available transmission times typically create coexistence problems for devices operating in accordance with two different protocols (e.g., LTE-U and WLAN). Generally, the WLAN devices may not detect the presence of an LTE-U signal, and thus being unaware of the presence of LTE-U communication while transmitting WLAN signals. Such coexisting operations would cause interference for the LTE-U communications, and may limit access for the LTE-U device to the same frequency spectrum during desired time periods. The LTE-U communications may also be causing interference for the WLAN communications. As a result, the WLAN and the LTE-U devices may experience degradation of communication data throughput as well as collisions of transmitted signals. Various aspects of the disclosure improve the efficiency of using the unlicensed frequency spectrum in wireless communication system 100 where the possibility exists for different transmissions to occur in accordance with WLAN and LTE-U protocols. In accordance with an embodiment, BS 104, while providing wireless connectivity services in accordance with LTE-U protocol protocols, transmits WLAN communications.

In accordance with various aspects of the disclosure and as described in more detail below, wireless communications typically coexistence problems occur when different systems operate by sharing the same communication resources, such as time and frequency resources. For example, an LTE-U signal (for example, over wireless communication link 110) may be received at a level that is below the energy detection level at a WLAN device (such as AP 108). Accordingly, WLAN devices may be unaware of LTE-U communications and may transmit during LTE-U communications which would interfere with the LTE-U communication as well as the LTE-U communication interfering with the WLAN communications. In such scenarios, both the WLAN and the LTE-U devices may experience throughput degradation from interference and collisions between the two communication protocols. It may be desirable to WLAN devices to detect LTE-U devices and LTE-U communications so that the WLAN devices may adjust their operation to improve throughput and communication efficiency of the system. Embodiments described herein relate to coexistence between LTE-U and WLAN devices, however, they may also apply to other RATs and protocols.

In general, BS 104 and/or BS 105 can transmit LTE-U communications implementing carrier sensing adaptive transmission (CSAT) with duty cycles of up to 640 ms on and 640 ms off. In some embodiments, the LTE-U communications do not implement listen before talk (LBT) rules. In various embodiments, each LTE-U communication can include one or more notches or silent periods during which no LTE-U communication is transmitted in order to enable other wireless devices to transmit without interference.

In some embodiments, BS 104 and/or 105 can reserve the wireless medium for LTE-U communications. For example, BS 104 and/or 105 can protect a time of LTE-U transmission from WLAN devices using one or more WLAN protection indications such as a contention-based clear-to-send (CTS)-to-self (C2S) or other WLAN protection indication (including 802.11a packets or transmitted in a non-HT duplicate mode of transmission). As a contention based WLAN protection indication, in some embodiments, the transmission time can be unknown beforehand.

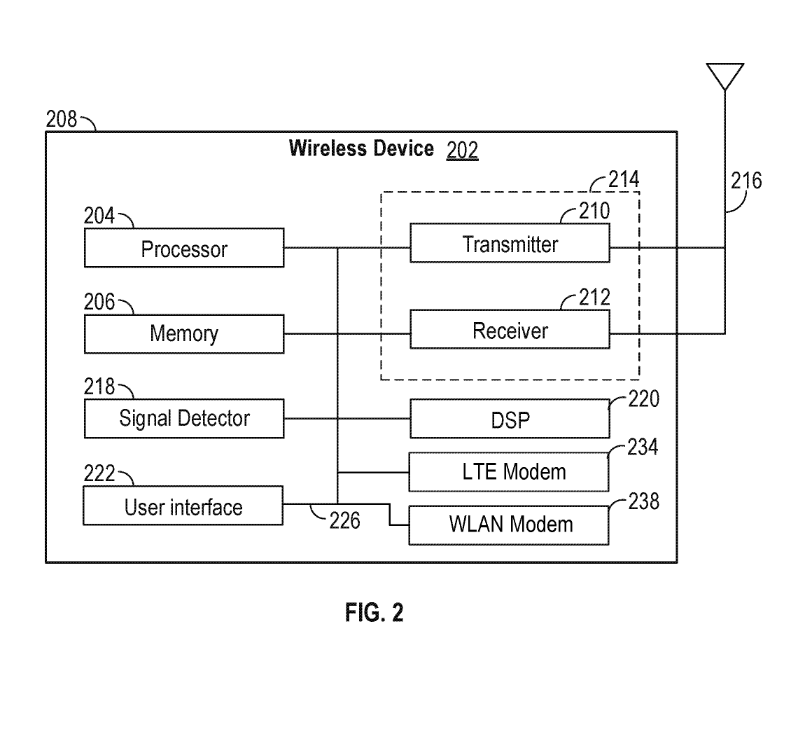

FIG. 2 illustrates various components of a wireless device 202 for operation in wireless communication system 100. The wireless device 202 is suitable for performing the operations as may be required by BS 104, AP 108 or STA 106. The wireless device 202 may be configured and used differently for BS 104, AP 108 or STA 106 depending on the various operations that may be required in wireless communication system 100.

The wireless device 202 may include a processor 204 which may control operation of wireless device 202. Processor 204 may also be referred to as a central processing unit (CPU) or hardware processor. Processor 204 typically performs logical and arithmetic operations based on program instructions stored within a memory 206 which may include both read-only memory (ROM) and random access memory (RAM). A portion of memory 206 may also include non-volatile random access memory (NVRAM). The instructions in memory 206 may be executable to implement various aspects described herein. Processor 204 may include or be a component of a processing system implemented with one or more processors and may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

Processor 204 and memory 206 may include non-transitory machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. The processor 204 may further include a data packet generator to generate data packets for controlling operation and data communication.

Wireless device 202 may include a transmitter 210 and a receiver 212 to allow wireless transmission and reception of data. Transmitter 210 and receiver 212 may be combined into a transceiver 214. An antenna 216 may be electrically coupled to transceiver 214. Although not shown, wireless device 202 may include multiple transmitters, multiple receivers, and/or multiple antennas. In an embodiment, although not shown, an antenna may be dedicated for each of the LTE-U and WLAN communications. Moreover, a receiver and a transmitter may be dedicated to for each of the LTE-U and WLAN communications. The operations associated with LTE-U and WLAN communications may also be performed collectively by the same receiver and transmitter. Wireless device 202 may be enclosed by a housing unit 208.

Wireless device 202 may also include an LTE modem 234 for LTE-U communications. Wireless device 202 may also include a WLAN modem 238 for WLAN communication. LTE modem 234 and WLAN modem 238 may contain processing capabilities for operations associated with processing at both the physical (PHY) layer and the medium access control (MAC) layer of the corresponding LTE-U and WLAN protocols. Although LTE modem 234 and WLAN modem 238 are shown separately, one of ordinary skill in the art may appreciate that the functions performed by these two components may be performed by a common component of wireless device 202, or their functions can be linked via hardware and/or software. Moreover, the functions associated with LTE modem 234 and WLAN modem 238 may also be performed by other components such as processor 204 and a digital signal processor (DSP) 220.

Wireless device 202 may transmit and receive both LTE-U and WLAN communications over antenna 216, transmitter 210, and receiver 212, each of which may be operationally connected to LTE modem 234 and WLAN modem 238. As disclosed herein, wireless device 202 may not require all the functionalities and components as shown and described when wireless device 202 is being used and implemented in AP 108, BS 104 or STA 106. In accordance with the disclosure, the basic functionality of WLAN modem 238 may be limited to processing transmission of WLAN data packets. For example, wireless communication link 110 between BS 104 and STA 106 may include transmission and reception of LTE-U communication and transmission of WLAN communications. Therefore, in BS 104, the basic functionality of WLAN modem 238 may be limited to processing transmission of WLAN communications.

Wireless device 202 may also include a signal detector 218 to detect and quantify the level of received signals. Signal detector 218 may detect such signals in a form of detecting total energy, energy per subcarrier per symbol, power spectral density and others. Wireless device 202 may also include DSP 220 for use in processing signals. DSP 220 may operationally be connected and share resources with processor 204 and other components.

Wireless device 202 may further include a user interface 222 in some aspects. User interface 222 may include any element such as a keypad, a microphone, a speaker, and/or a display for conveying information to a user of wireless device 202 and/or receives input from the user. Various components of wireless device 202 may be coupled together by a bus system 226 which may include for example a data bus, a power bus, a control signal bus, and a status signal bus.

Although a number of separate components are illustrated in FIG. 2, one of ordinary skill in the relevant art would appreciate that one or more of these components may be implemented not only with respect to the functionality described above, but also to perform the functionality associated with respect to other components. For example, processor 204 may be used to perform not only the functionality described with respect to processor 204, but also the functionality associated with signal detector 218 and/or DSP 220. Each of the components illustrated in FIG. 2 may be implemented using a plurality of separate elements.

In an exemplary embodiment, BS 104 may be configured for communicating in accordance with the operation of LTE-U protocol while also configured to transmit in accordance with the WLAN protocol. As such, when wireless device 202 is configured to operate as BS 104, WLAN modem 238 can be configured to form and facilitate transmission of such WLAN communications from BS 104. Further, in accordance with an embodiment, when transmitted by BS 104, the WLAN communication is embedded with information about a selective contention period (SCP) in which WLAN devices (or a subset thereof) can transmit WLAN communications without interference by LTE-U communications. The transmission of the WLAN communication may be incorporated with LTE-U communications for improving or ensuring availability of frequency spectrum and timing resources for the LTE-U communications to take place having reduced receive interference from other possible WLAN communications in the unlicensed frequency spectrum. BS 104 while incorporating transmission of a WLAN communication with LTE-U communications to STA 106 or any other device reduces the possibility of experiencing interference at a receiver of the LTE-U communication from transmission of WLAN communication by other WLAN devices in wireless communication system 100. While referring to a configuration of wireless device 202 in BS 104, processor 204 or DSP 220 may operate with LTE modem 234 and WLAN modem 238 for generating and transmitting the WLAN communication and the LTE-U communication in accordance with an exemplary embodiment. In accordance with an embodiment, the WLAN communication may also be embedded with information about LTE-U communication.

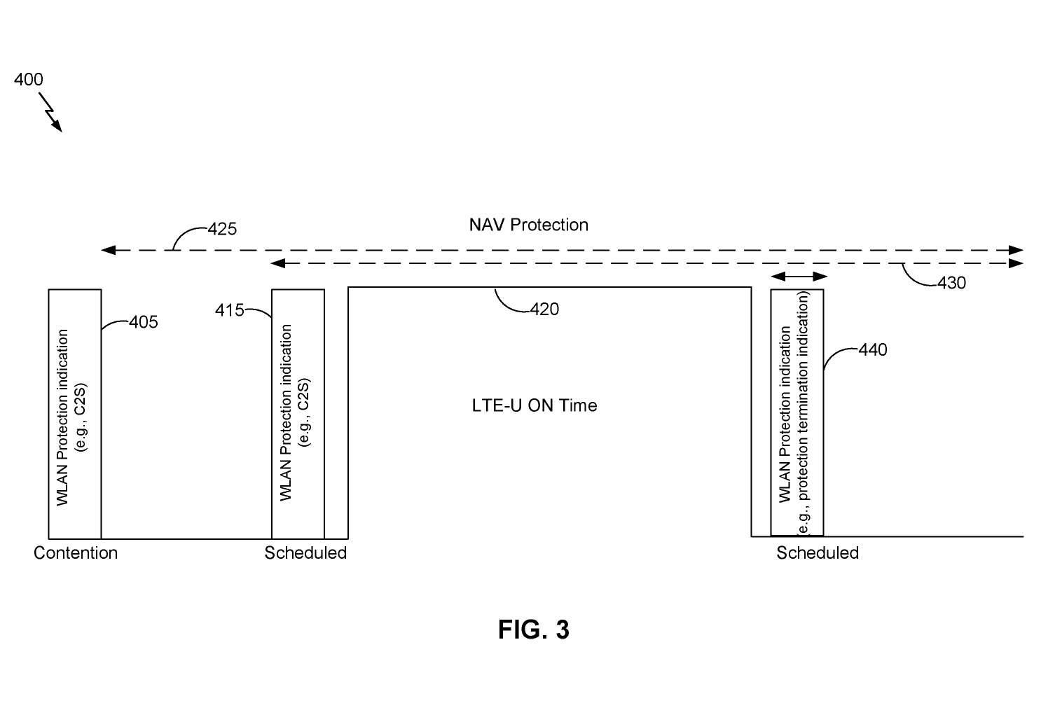

When in close proximity to the BS 104, AP 108 may also receive transmissions made by BS 104. As such, AP 108 is also receiving the WLAN communication having been incorporated in the LTE-U communication and transmitted by BS 104. AP 108 while receiving such a transmission from BS 104 may defer transmission of its own WLAN communication in order to receive the SCP communication. As such, the SCP communication transmitted by BS 104 may continue to be received at STA 106 at possibly a reduced level of interference or with no interference from possible WLAN transmissions by AP 108. Other WLAN devices in wireless communication system 100 receiving the WLAN communication having been incorporated in the LTE-U communication and transmitted by BS 104 may also defer transmission of their own WLAN communication or may communicate by transmitting on a different channel than the frequency channel used for the LTE-U communication. The WLAN communication having been incorporated in the LTE-U communication, as such, protects transmission and reception of the SCP communication at a reduced level of interference or with no interference from other possible WLAN transmissions in wireless communication system 100. Various examples of the WLAN communication protecting the SCP communication, and subsequent use of the SCP for transmission of WLAN communications by WLAN devices, are shown and described below with respect to FIGS. 3-5.

As discussed above, LTE-U transmissions can be scheduled transmissions, as opposed to contention-based transmissions. For example, LTE modem 234 can schedule each LTE-U transmission. However, in various embodiments, the interface between LTE modem 234 and WLAN modem 238 can be too slow to dynamically determine the duration of LTE-U protection for inclusion in the contention-based WLAN protection indication. Thus, in some embodiments, a reservation duration of the contention-based WLAN protection indication is not determined on the fly.

Instead, the contention-based WLAN protection indication can be transmitted long before the LTE-U transmission. In some embodiments, the contention-based WLAN protection indication can over-protect the LTE-U transmission (for example, reserving the wireless medium for longer than used by the LTE-U transmission), thereby leading to potentially inefficient channel use. Accordingly, systems and methods for efficient waveform protection are desired.

FIG. 3 illustrates a time sequence diagram 400 of exemplary communications between LTE and WLAN devices, according to one embodiment. This embodiment illustrates an exemplary communication exchange within wireless communication system 100 of FIG. 1. Although FIG. 3 is described with respect to LTE-U communications, the teachings herein are applicable to coexistence between other sets of wireless communications technologies. For example, in some embodiments, LTE-U communications can be replaced with 802.11ax communications. Although various communications are shown, additional communications can be added, any communication shown can be omitted, and the timing or order of communications rearranged.

In the illustrated embodiment of FIG. 3, BS 104 transmits a first WLAN protection indication 405. In some embodiments, WLAN modem 238 (FIG. 2) can transmit the first WLAN protection indication 405, for example via coordination with LTE modem 234 (FIG. 2). In some embodiments LTE modem 234 (FIG. 2) may transmit the first WLAN protection indication 405. In various embodiments, the first WLAN protection indication 405 can include a transmission reserving the wireless medium that is decodable by, for example, an 802.11 device. In some embodiments, the first WLAN protection indication 405 can include, for example, a clear-to-send (CTS)-to-self (C2S) packet indicating that the wireless medium is reserved for a specified period of time, for example network allocation vector (NAV) 425. In other embodiments, other packets can be used for medium reservation (including 802.11a packets). In some embodiments WLAN protection indication is transmitted in a non-HT duplicate mode of transmission.

In the illustrated embodiment, the first WLAN protection indication 405 is a contention-based transmission. In various embodiments described herein, contention-based transmissions can use carrier-sense, listen-before-talk, or other collision avoidance approaches in order to contend for access to the wireless medium. In some embodiments, BS 104 can transmit a plurality of contention-based WLAN protection indications prior to an LTE-U transmission 420. In some embodiments, BS 104 can transmit a single contention-based WLAN protection indication prior to a plurality of scheduled WLAN protection indications.

In some embodiments, the first WLAN protection indication 405 can reserve the wireless medium until at least transmission of a second WLAN protection indication 415. For example, the first WLAN protection indication 405 can indicate that receiving STAs should set their network allocation vectors (NAVs) 425 until at least the start (or, in some embodiments, end) of the second WLAN protection indication 415.

In some embodiments, the first WLAN protection indication 405 can reserve the wireless medium until at least transmission of the LTE-U transmission 420. For example, the first WLAN protection indication 405 can indicate that receiving STAs should set their NAVs 425 until at least the start (or, in some embodiments, end) of the LTE-U transmission 420.

In some embodiments, the first WLAN protection indication 405 can reserve the wireless medium until at least transmission of a WLAN protection indication 440 (which can be a protection termination indication or other protection termination frame). For example, the first WLAN protection indication 405 can indicate that receiving STAs should set their NAVs 425 until at least the start (or, in some embodiments, end) of the WLAN protection indication 440.

The first WLAN protection indication 405 serves to improve detection probability of one or more subsequent WLAN protection indications such as, for example, the second WLAN protection indication 415. The BS 104 can transmit the second WLAN protection indication 415 after the first WLAN protection indication 405 and before the LTE-U transmission 420. Thus, BS 104 can transmit the second WLAN protection indication 415 during NAV 425 set by the first WLAN protection indication 405.

In some embodiments, WLAN modem 238 (FIG. 2) can transmit the second WLAN protection indication 415, for example via coordination with LTE modem 234 (FIG. 2). In some embodiments LTE modem 234 (FIG. 2) may transmit WLAN protection indication 415. In various embodiments, the second WLAN protection indication 415 can include a transmission reserving the wireless medium that is decodable by, for example, an 802.11 device. In some embodiments, the second WLAN protection indication 415 can include, for example, a clear-to-send (CTS)-to-self (C2S) packet indicating that the wireless medium is reserved for a specified period of time (for example, NAV 430). In other embodiments, other packets can be used for medium reservation (including 802.11a packets or transmitted in a non-HT duplicate mode of transmission).

In the illustrated embodiment, the second WLAN protection indication 415 is a scheduled transmission. In various embodiments described herein, scheduled transmissions do not contend for access to the wireless medium. Accordingly, BS 104 can transmit the second WLAN protection indication 415 regardless of traffic on the wireless medium. In some embodiments, BS 104 can transmit a plurality of scheduled-based WLAN protection indications prior to the LTE-U transmission 420.

In some embodiments, the second WLAN protection indication 415 can reserve the wireless medium until at least transmission of the LTE-U transmission 420. For example, the second WLAN protection indication 415 can indicate that receiving STAs should set their NAVs 430 until at least the start (or, in some embodiments, end) of the LTE-U transmission 420.

In some embodiments, the second WLAN protection indication 415 can reserve the wireless medium until at least transmission of the WLAN protection indication 440 (or other protection termination frame). For example, the second WLAN protection indication 415 can indicate that receiving STAs should set their NAVs 430 until at least the start (or, in some embodiments, end) of the WLAN protection indication 440.

The second WLAN protection indication 415 serves to protect the LTE-U transmission 420 from interference from WLAN devices such as, for example, AP 108. The BS 104 can transmit the LTE-U transmission 420 after the second WLAN protection indication 415 and before WLAN protection indication 440. Thus, BS 104 can transmit the LTE-U transmission 420 during NAV 430 set by the second WLAN protection indication 415. In some embodiments, BS 104 can also transmit the LTE-U transmission 420 during NAV 425 set by the first WLAN protection indication 405. In some embodiments, LTE modem 234 (FIG. 2) can transmit the LTE-U transmission 420.

In the illustrated embodiment, the LTE-U transmission 420 is a scheduled transmission. In various embodiments described herein, scheduled transmissions do not contend for access to the wireless medium. Accordingly, BS 104 can transmit the LTE-U transmission 420 regardless of traffic on the wireless medium.

The WLAN protection indication 440 serves to indicate that wireless devices should set or reset their NAVs 425 or 430. The BS 104 can transmit WLAN protection indication 440 after the LTE-U transmission 420. In some embodiments, BS 104 can transmit WLAN protection indication 440 during NAV 430 set by the second WLAN protection indication 415. In some embodiments, BS 104 can also transmit WLAN protection indication 440 during NAV 425 set by the first WLAN protection indication 405. In some embodiments, LTE modem 234 (FIG. 2) can transmit the LTE-U transmission 420.

In some embodiments, WLAN modem 238 (FIG. 2) can transmit WLAN protection indication 440, for example via coordination with LTE modem 234 (FIG. 2). In some embodiments LTE modem 234 (FIG. 2) may transmit WLAN protection indication 440. In various embodiments, WLAN protection indication 440 can include a transmission releasing the wireless medium that is decodable by, for example, an 802.11 device. In some embodiments, WLAN protection indication 440 can include, for example, a contention free period (CF)-end packet indicating that the wireless medium is released. In other embodiments, other protection termination packets can be used. By releasing the wireless medium for use by non-LTE-U devices, WLAN protection indication 440 can allow increased channel utilization. In some embodiments LTE modem 234 may transmit WLAN protection indication 440.

In the illustrated embodiment, WLAN protection indication 440 is a scheduled transmission. In various embodiments described herein, scheduled transmissions do not contend for access to the wireless medium. Accordingly, BS 104 can transmit WLAN protection indication 440 regardless of traffic on the wireless medium.

In various embodiments, all WLAN protection indications 405, 415, and 440 can be transmitted synchronously by all BSs (for example, BS 104 and BS 105). In some embodiments, all WLAN protection indications 405, 415, and 440 can include identical parameters across all BSs 104 and 105 (such as, for example, WLAN scrambler seed, common address fields, modulation and coding schemes, etc.). In other embodiments, WLAN protection indications 405, 415, and 440 can include different parameters as between different BSs 104 and 105.

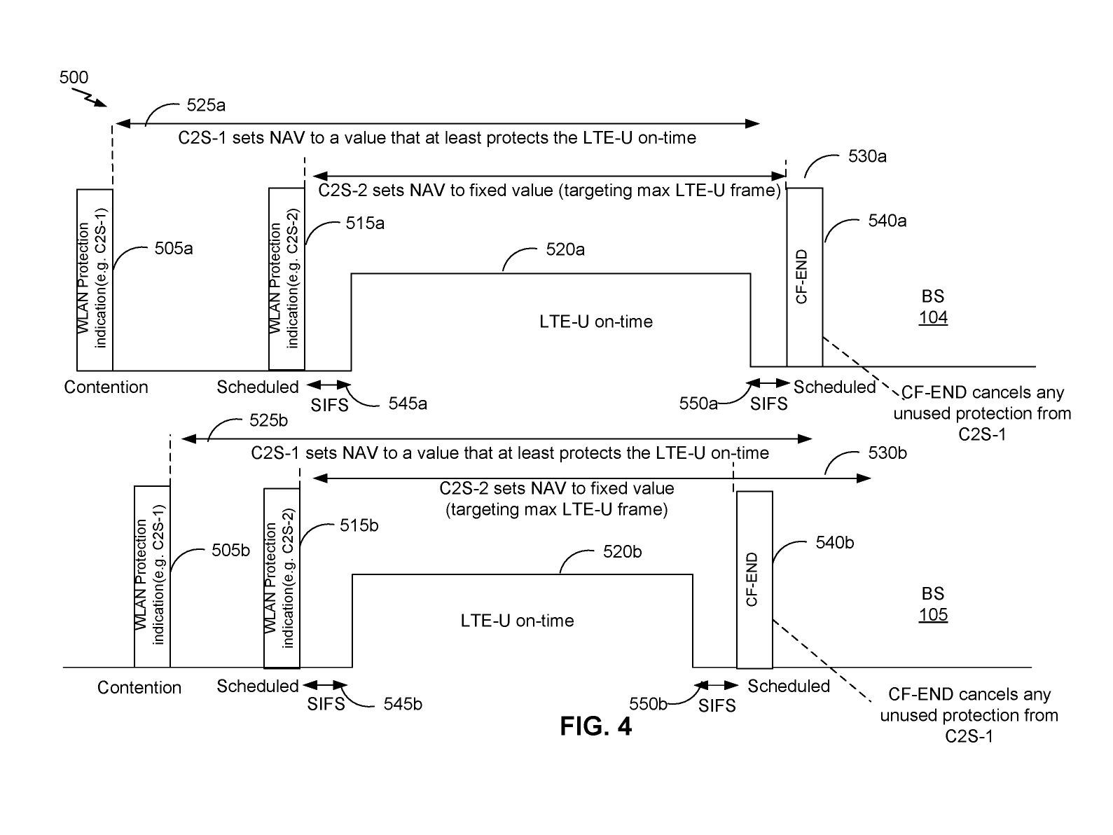

In various embodiments, LTE-U transmissions can have a different duration as between different BSs 104 and 105. In some embodiments, the LTE-U transmissions can have synchronous start times and asynchronous end times as between different BSs 104 and 105. One example of synchronous start times and asynchronous end times is shown in FIG. 4.

FIG. 4 illustrates a time sequence diagram 500 of exemplary communications between LTE and WLAN devices, according to another embodiment. This embodiment illustrates an exemplary communication exchange within wireless communication system 100 of FIG. 1. Although FIG. 4 is described with respect to LTE-U communications, the teachings herein are applicable to coexistence between other sets of wireless communications technologies. For example, in some embodiments, LTE-U communications can be replaced with 802.11ax communications. Although various communications are shown, additional communications can be added, any communication shown can be omitted, and the timing or order of communications rearranged.

As shown in the upper portion of FIG. 4, the BS 104 transmits the first WLAN protection indication 505a. In some embodiments, WLAN modem 238 (FIG. 2) can transmit the first WLAN protection indication 505a, for example via coordination with LTE modem 234 (FIG. 2). In some embodiments LTE modem 234 (FIG. 2) may transmit the first WLAN protection indication 505a. In various embodiments, the first WLAN protection indication 505a can include a transmission reserving the wireless medium that is decodable by, for example, an 802.11 device. In some embodiments, the first WLAN protection indication 505a can include, for example, a clear-to-send (CTS)-to-self (C2S) packet indicating that the wireless medium is reserved for a specified period of time (for example, NAV 525a). In other embodiments, other packets can be used for medium reservation (including 802.11a packets or transmitted in a non-HT duplicate mode of transmission).

In the illustrated embodiment, the first WLAN protection indication 505a is a contention-based transmission. In various embodiments described herein, contention-based transmissions can use carrier-sense, listen-before-talk, or other collision avoidance approaches in order to contend for access to the wireless medium. In some embodiments, the BS 104 can transmit a plurality of contention-based WLAN protection indications prior to an LTE-U transmission 520a. In the illustrated embodiment, the first WLAN protection indication 505a contends with a WLAN protection indication 505b transmitted by the BS 105. Accordingly, as a contention-based communication, WLAN protection indication 505a and WLAN protection indication 505b are transmitted asynchronously. As shown in FIG. 4, the first WLAN protection indication 505a wins contention, and is therefore transmitted before WLAN protection indication 505b. In other embodiments, other orders are possible based on the wireless environment and contention circumstances.

In some embodiments, the first WLAN protection indication 505a can reserve the wireless medium until at least transmission of a second WLAN protection indication 515a. For example, the first WLAN protection indication 505a can indicate that receiving STAs should set their network allocation vectors (NAVs) 525a until at least the start (or, in some embodiments, end) of the second WLAN protection indication 515a.

In some embodiments, the first WLAN protection indication 505a can reserve the wireless medium until at least transmission of the LTE-U transmission 520a. For example, the first WLAN protection indication 505a can indicate that receiving STAs should set their NAVs 525a until at least the start (or, in some embodiments, end) of the LTE-U transmission 520a.

In some embodiments, the first WLAN protection indication 505a can reserve the wireless medium until at least transmission of a protection termination indication 540a (or other protection termination frame). For example, the first WLAN protection indication 505a can indicate that receiving STAs should set their NAVs 525a until at least the start (or, in some embodiments, end) of the protection termination indication 540a. In the illustrated embodiment, the first WLAN protection indication 505a reserves the wireless medium until the start of protection termination indication 540a.

The first WLAN protection indication 505a serves to improve detection probability of one or more subsequent WLAN protection indications such as, for example, the second WLAN protection indication 515a. The BS 104 can transmit the second WLAN protection indication 515a after the first WLAN protection indication 505a and before the LTE-U transmission 520a. Thus, the BS 104 can transmit the second WLAN protection indication 515a during NAV 525a set by the first WLAN protection indication 505a.

In some embodiments, WLAN modem 238 (FIG. 2) can transmit the second WLAN protection indication 515a, for example via coordination with LTE modem 234 (FIG. 2). In some embodiments LTE modem 234 (FIG. 2) may transmit the second WLAN protection indication 515a. In various embodiments, the second WLAN protection indication 515a can include a transmission reserving the wireless medium that is decodable by, for example, an 802.11 device. In some embodiments, the second WLAN protection indication 515a can include, for example, a clear-to-send (CTS)-to-self (C2S) packet indicating that the wireless medium is reserved for a specified period of time (for example, NAV time period 530a). In other embodiments, other packets can be used for medium reservation (including 802.11a packets or transmitted in a non-HT duplicate mode of transmission).

In the illustrated embodiment, the second WLAN protection indication 515a is a scheduled transmission. In various embodiments described herein, scheduled transmissions do not contend for access to the wireless medium. Accordingly, the BS 104 can transmit the second WLAN protection indication 515a regardless of traffic on the wireless medium. In some embodiments, the BS 104 can transmit a plurality of scheduled-based WLAN protection indications prior to the LTE-U transmission 520a. In the illustrated embodiment, the BS 104 transmits WLAN protection indication 515a synchronously as the BS 105 transmits a WLAN protection indication 515b.

In some embodiments, in absence of winning contention successfully a BS (for example, BS 104) can refrain from transmitting the contention-based WLAN protection indication (for example, WLAN protection indication 505a) and may directly transmit the scheduled WLAN protection indication (for example, WLAN protection indication 515a).

In some embodiments, the second WLAN protection indication 515a can reserve the wireless medium until at least transmission of the LTE-U transmission 520a. For example, the second WLAN protection indication 515a can indicate that receiving STAs should set their NAVs 530a until at least the start (or, in some embodiments, end) of the LTE-U transmission 520a.

In some embodiments, the second WLAN protection indication 515a can reserve the wireless medium until at least transmission of the protection termination indication 540a (or other protection termination frame). For example, the second WLAN protection indication 515a can indicate that receiving STAs should set their NAVs 530a until at least the start (or, in some embodiments, end) of the protection termination indication 540a.

In the illustrated embodiment, the second WLAN protection indication 515a reserves the wireless medium for a maximum allowable LTE-U frame size. For example, the second WLAN protection indication 515a indicates that receiving STAs should set their NAVs 530a to a maximum LTE-U frame size. Accordingly, in embodiments where the maximum LTE-U frame size is smaller than a maximum NAV duration, the second WLAN protection indication 515a protects the entire LTE-U transmission 520a.

The second WLAN protection indication 515a serves to protect the LTE-U transmission 520a from interference from WLAN devices such as, for example, AP 108. The BS 104 can transmit the LTE-U transmission 520a after the second WLAN protection indication 515a and before protection termination indication 540a. In an embodiment, the BS 104 can transmit the LTE-U transmission 520a a fixed amount of time 545a after WLAN protection indication 515a such as, for example, a short interframe space (SIFS) time 545a. In some embodiments, time 545a can be zero. In some embodiments time 545a may be chosen to enable slot-synchronization between LTE and WLAN waveforms. In some embodiments the BS 104 may transmit a ‘filler waveform’ during time 545a, the ‘filler waveform’ comprising LTE-U OFDM symbols or parts thereof. Thus, the BS 104 can transmit the LTE-U transmission 520a during NAV time period 530a set by the second WLAN protection indication 515a. In some embodiments, the BS 104 can also transmit the LTE-U transmission 520a during NAV 525a set by the first WLAN protection indication 505a. In some embodiments, LTE modem 234 (FIG. 2) can transmit the LTE-U transmission 520a.

In the illustrated embodiment, the LTE-U transmission 520a is a scheduled transmission. In various embodiments described herein, scheduled transmissions do not contend for access to the wireless medium. Accordingly, the BS 104 can transmit the LTE-U transmission 520a regardless of traffic on the wireless medium. In the illustrated embodiment, the BS 104 starts transmission of the LTE-U transmission 520a synchronously as the BS 105 starts transmission of a LTE-U transmission 520b. In the illustrated embodiment, the BS 104 ends transmission of the LTE-U transmission 520a asynchronously as the BS 105 ends transmission of the LTE-U transmission 520b.

The protection termination indication 540a serves to indicate that wireless devices should set or reset their NAVs 525a or 530a. The BS 104 can transmit protection termination indication 540a after the LTE-U transmission 520a. In an embodiment, the BS 104 can transmit protection termination indication 540a a fixed amount of time 550a after the LTE-U transmission 520a such as, for example, a SIFS time 545a. In some embodiments, time 550a can be zero. In some embodiments time 550a may be chosen to enable slot-synchronization between LTE and WLAN waveforms. In some embodiments the BS 104 may transmit a ‘filler waveform’ during time 550a, the ‘filler waveform’ comprising LTE-U OFDM symbols or parts thereof. In some embodiments, time 550a can be greater than time 545a. In some embodiments, the BS 104 can transmit protection termination indication 540a during NAV time period 530a set by the second WLAN protection indication 515a. In some embodiments, the BS 104 can also transmit protection termination indication 540a during NAV 525a set by the first WLAN protection indication 505a. In some embodiments, LTE modem 234 (FIG. 2) can transmit the LTE-U transmission 520a.

In some embodiments, WLAN modem 238 (FIG. 2) can transmit protection termination indication 540a, for example via coordination with LTE modem 234 (FIG. 2). In some embodiments, LTE modem 234 can transmit protection termination indication 540a. In various embodiments, protection termination indication 540a can include a transmission releasing the wireless medium that is decodable by, for example, an 802.11 device. In some embodiments, protection termination indication 540a can include, for example, a contention free period (CF)-end packet indicating that the wireless medium is released. In other embodiments, other protection termination packets can be used. By releasing the wireless medium for use by non-LTE-U devices, protection termination indication 540a can allow increased channel utilization.

In the illustrated embodiment, protection termination indication 540a is a scheduled transmission. In various embodiments described herein, scheduled transmissions do not contend for access to the wireless medium. Accordingly, the BS 104 can transmit protection termination indication 540a regardless of traffic on the wireless medium. In the illustrated embodiment, the BS 104 transmits protection termination indication 540a asynchronously as the BS 105 transmits a protection termination indication 540b, which is illustrated for example as a CF-End.

In various embodiments, asynchronous termination of wireless medium protection can provide more opportunity for WLAN devices to transmit after termination of the LTE-U transmissions 520a and 520b. For example, a STA within range of the BS 105, but not within range of the BS 104, could start transmitting after the Protection termination indication 540b, but before the protection termination indication 540a.

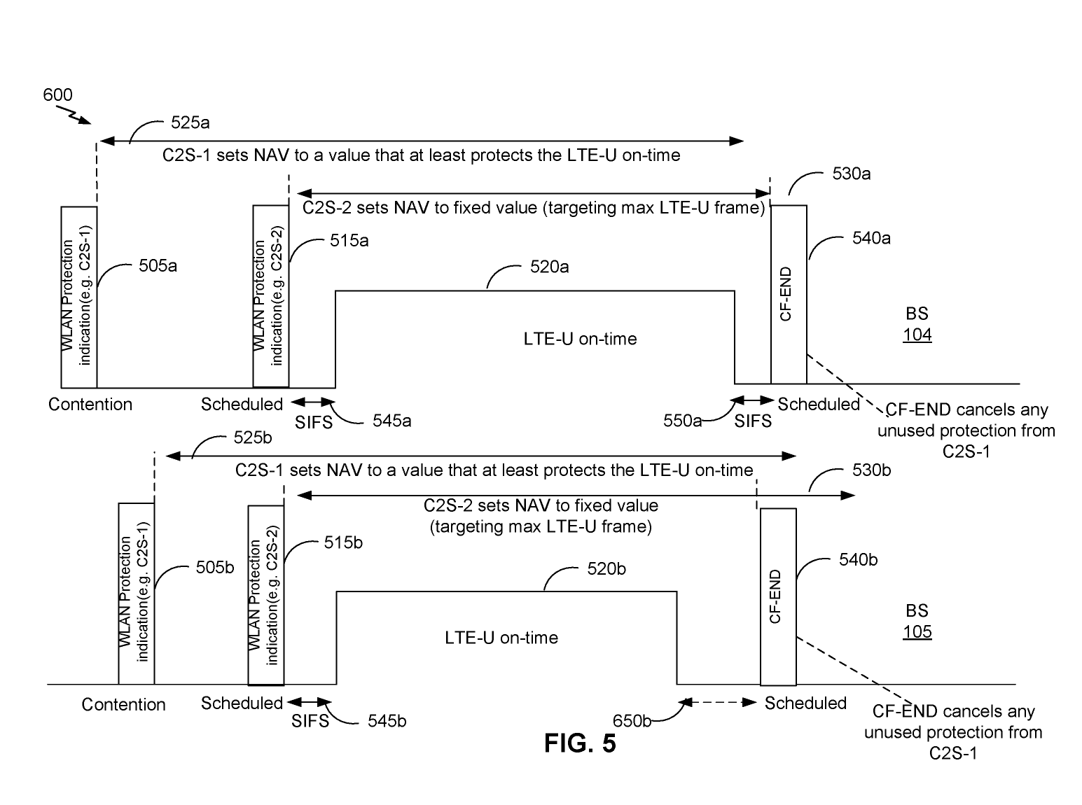

As shown in FIG. 4, protection termination indication 540a from the BS 104 and protection termination indication 540b from the BS 105 are transmitted asynchronously. In other embodiments, the protection termination indications from different BSs can be transmitted synchronously. Such an embodiment is shown in FIG. 5.

FIG. 5 illustrates a time sequence diagram 600 of exemplary communications between LTE and WLAN devices, according to another embodiment. This embodiment illustrates an exemplary communication exchange within wireless communication system 100 of FIG. 1. Although FIG. 5 is described with respect to LTE-U communications, the teachings herein are applicable to coexistence between other sets of wireless communications technologies. For example, in some embodiments, LTE-U communications can be replaced with 802.11ax communications. Although various communications are shown, additional communications can be added, any communication shown can be omitted, and the timing or order of communications rearranged.

FIG. 5 includes transmissions 505a-505b, 515a-505b, 520a-520b, and 540a-540b of FIG. 4, with the difference that protection termination indication 540b from the BS 105 is transmitted synchronously with protection termination indication 540a from the BS 104. Accordingly, time 650b between transmission of the LTE-U transmission 520b and protection termination indication 540b of the BS 105 is longer than time 550a between transmission of the LTE-U transmission 520a and protection termination indication 540a of the BS 104.

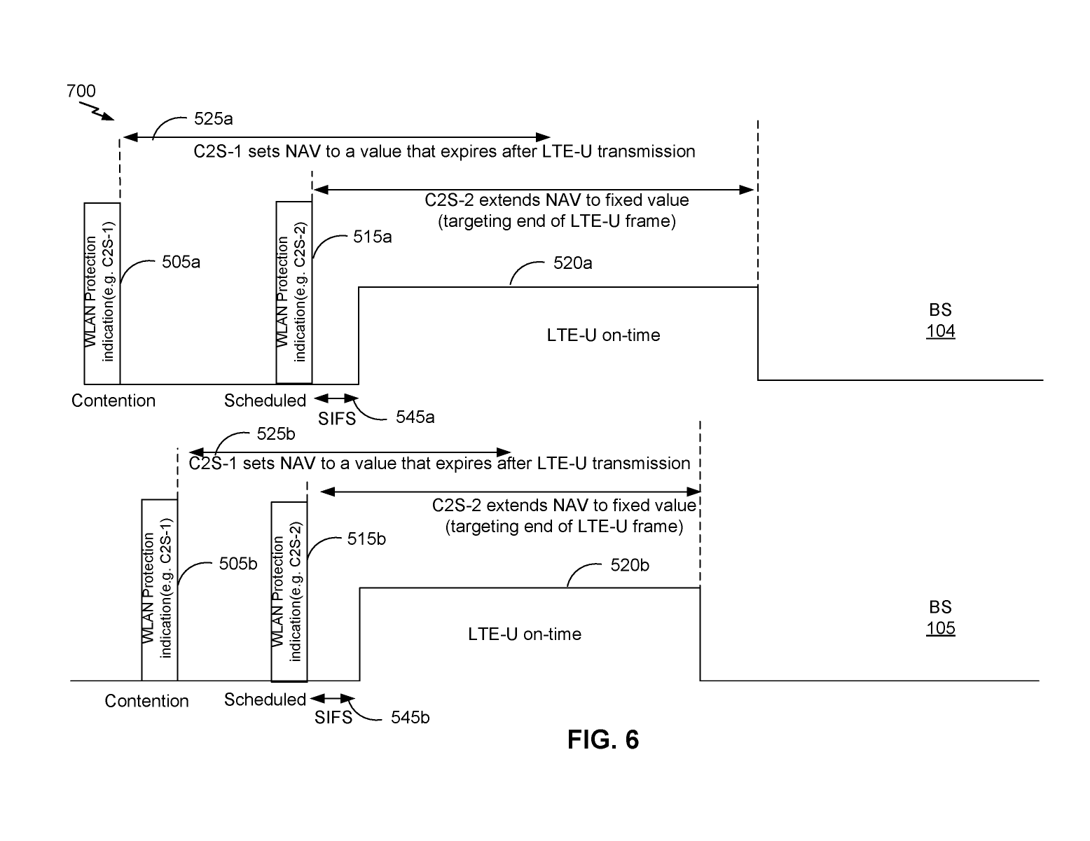

In some embodiments, the protection termination indications (for example, protection termination indications 540a and 540b) can be omitted. Such an embodiment is shown in FIG. 6.

FIG. 6 illustrates a time sequence diagram 700 of exemplary communications between LTE and WLAN devices, according to another embodiment. This embodiment illustrates an exemplary communication exchange within wireless communication system 100 of FIG. 1. Although FIG. 6 is described with respect to LTE-U communications, the teachings herein are applicable to coexistence between other sets of wireless communications technologies. For example, in some embodiments, LTE-U communications can be replaced with 802.11ax communications. Although various communications are shown, additional communications can be added, any communication shown can be omitted, and the timing or order of communications rearranged.

FIG. 6 includes transmissions 505a-505b, 515a-515b, and 520a-520b of FIG. 4, with the difference that protection termination indications 540a-540b are omitted. Accordingly, WLAN protection indication 515a is configured to reserve the wireless medium only until the end of the LTE-U transmission 520a. Likewise, WLAN protection indication 515b is configured to reserve the wireless medium only until the end of the LTE-U transmission 520b. Because, in the illustrated embodiment, the LTE-U transmission 520a and the LTE-U transmission 520b end asynchronously, WLAN protection indication 515a and WLAN protection indication 515b will include different parameters. For example, one or more final bytes of WLAN protection indication 515a can differ from those of WLAN protection indication 515a such as, for example, a duration field and cyclic redundancy check (CRC) field.

Although NAV time period 530a and 530b values are shown as extending through the same time as the LTE-U transmissions 520a and 520b, respectively, in other embodiments NAV time period 530a and 530b values can extend beyond the LTE-U transmissions 520a and 520b (for example, by a fixed, preset, or dynamically determined amount). In some embodiments, NAV time period 530a and 530b values do not extend for the duration of the LTE-U transmissions 520a and 520b. Accordingly, in some embodiments, at least a portion of the LTE-U transmissions 520a and 520b is not protected by WLAN protection indications 515a and 515b.

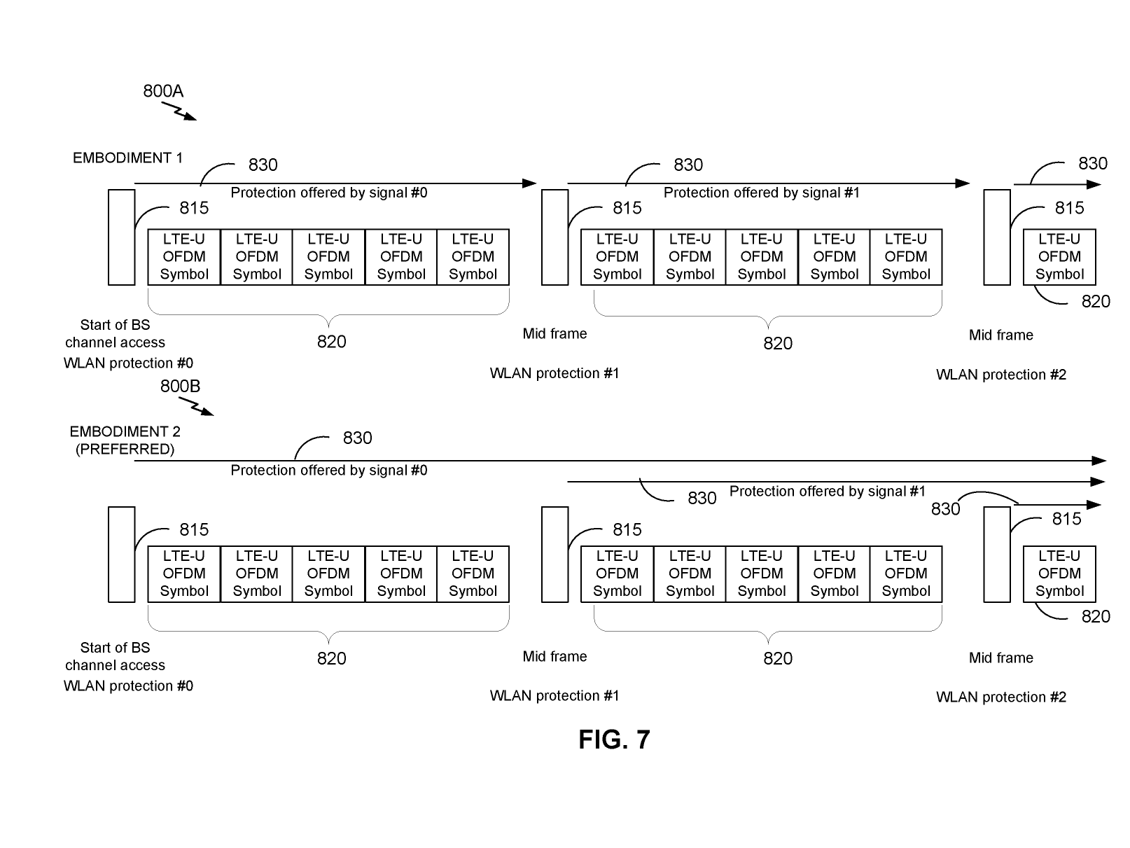

In some embodiments, LTE-U transmissions can be longer than a maximum time for reserving the wireless medium. For example, in some embodiments, LTE-U transmissions can be 640 ms long, and a maximum NAV duration can be 32 ms. In some embodiments, BS 104 can transmit one or more WLAN protection indications during the LTE-U transmissions. Examples of two such embodiments are shown in FIG. 7.

FIG. 7 illustrates time sequence diagrams 800A-800B of exemplary communications between LTE and WLAN devices, according to various embodiments. The embodiments illustrate exemplary communication exchanges 800A-800B within communication system 100 of FIG. 1. Although FIG. 7 is described with respect to LTE-U communications, the teachings herein are applicable to coexistence between other sets of wireless communications technologies. For example, in some embodiments, LTE-U communications can be replaced with 802.11ax communications. Although various communications are shown, additional communications can be added, any communication shown can be omitted, and the timing or order of communications rearranged.

As shown in the upper portion of FIG. 7, a first communication exchange 800A includes a plurality of LTE-U symbols 820 forming an LTE-U transmission. In the illustrated embodiment of FIG. 7, BS 104 transmits a plurality of WLAN protection indications 815 interspersed with the LTE-U symbols 820. In some embodiments, WLAN modem 238 (FIG. 2) can transmit WLAN protection indications 815, for example via coordination with LTE modem 234 (FIG. 2). Likewise, LTE modem 234 can transmit the LTE-U symbols 820. In some embodiments LTE modem 234 (FIG. 2) can transmit WLAN protection indications 815.

In various embodiments, WLAN protection indications 815 can each include a transmission reserving the wireless medium that is decodable by, for example, an 802.11 device. In some embodiments, WLAN protection indications 815 can each include, for example, a clear-to-send (CTS)-to-self (C2S) packet indicating that the wireless medium is reserved for a specified period of NAV time 830. In other embodiments, other packets can be used for medium reservation (including 802.11a packets or transmitted in a non-HT duplicate mode of transmission).

In the illustrated embodiment, WLAN protection indications 815 are each scheduled transmissions. In various embodiments described herein, scheduled transmissions do not contend for access to the wireless medium. Accordingly, BS 104 can transmit WLAN protection indications 815 each regardless of traffic on the wireless medium.

In some embodiments, WLAN protection indications 815 can each reserve the wireless medium until at least transmission of the next WLAN protection indication 815. For example, each WLAN protection indication 815 can indicate that receiving STAs should set their network allocation vectors (NAVs) time 830 until at least the start (or, in some embodiments, end) of the next WLAN protection indication 815. Accordingly, NAV time 830 can be equal or about the periodicity of WLAN protection indications 815. In various embodiments, LTE modem 234 can stop transmitting LTE-U symbols 820 during transmission of WLAN protection indications 815. In other embodiments, WLAN modem 238 can puncture one or more LTE-U symbols 820 with WLAN protection indications 815. In various embodiments, periodicity of WLAN protection indications 815 can be in multiples of LTE-U symbols, slots, sub-frames, frames, etc.

In illustrated first communication exchange 800A, NAV time 830 is equal to the periodicity of WLAN protection indications 815. In other embodiments, NAV time 830 can be greater than the periodicity of WLAN protection indications 815 such as, for example, a multiple of the periodicity of WLAN protection indications 815. An example of one such embodiment is shown with respect to exchange 800B.

As shown in exchange 800B, each WLAN protection indications 815 sets a NAV time 830 greater than two times the periodicity of WLAN protection indications 815. In some embodiments, the ratio of NAV time 830 to WLAN protection indication 815 periodicity can be 2:1, 3:1, 4:1, and so on. In some embodiments, non-integer multiples can be used such as, for example, 3:2, 5:2, 7:2, and so on. It would be apparent to one skilled in art that exchange 800B provides greater reliability of protection, for example, due to the erasure of a single WLAN protection indication 815 at an interfering WLAN device by means of adequate repetition of protection indication 815 and the overlapping of their respective NAV times 830. It would be further apparent that this added reliability is at the cost of a larger number of WLAN protection indications than would be required in an exchange such as 800A.

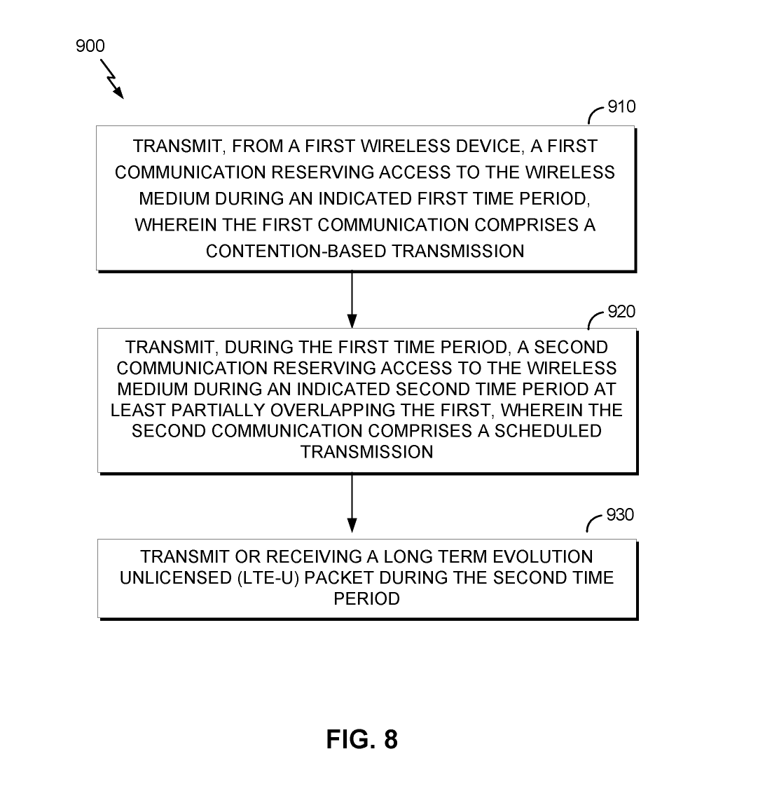

FIG. 8 shows a flowchart 900 for an example method of wireless communication that can be employed within wireless communication system 100 of FIG. 1. The method can be implemented in whole or in part by the devices described herein, such as wireless device 202 shown in FIG. 2. Although the illustrated method is described herein with reference to wireless communication system 100 discussed above with respect to FIG. 1 and communications 400-800 discussed above with respect to FIGS. 3-7, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

First, at block 910, a first wireless device transmits a first communication reserving access to the wireless medium during an indicated first time period. The first communication includes a contention-based transmission. For example, the first communication can be the C2S1 505a described above with respect to FIG. 4. The BS 104 can contend to transmit the C2S1 505a to one or more STAs which can set their NAVs 525a. In some embodiments, the first communication can be omitted.

Next, at block 920, the first wireless device transmits, during the first time period, a second communication reserving access to the wireless medium during an indicated second time period at least partially overlapping the first. The second communication includes a scheduled transmission. For example, the second communication can include the C2S2 515a described above with respect to FIG. 4. The BS 104 can schedule transmission of the C2S2 515a to one or more STAs which can update their NAVs 530a. In some embodiments, the second communication can be omitted.

Then, at block 930, the first wireless device transmits or receives a long term evolution unlicensed (LTE-U) transmission during the second time period. For example, BS 104 can transmit the LTE-U transmission 520a as described above with respect to FIG. 4. In some embodiments, the LTE-U transmission can be omitted.

In various embodiments, the first time period includes a time of transmission of the LTE-U transmission. For example, first NAV 525a duration can protect transmission of the LTE-U transmission 520a.

In various embodiments, the method can further include transmitting, after the LTE-U transmission, a third communication canceling reservation of access to the wireless medium by the first and second communications. The third communication can include a scheduled transmission. In various embodiments, the third communication includes a contention-free period end frame. For example, the third communication can include the protection termination indication 540a. The BS 104 can schedule transmission of the CF-end 540 after the LTE-U transmission 520a as described above with respect to FIG. 4. In some embodiments, the third communication can be omitted (see FIG. 6, for example).

In various embodiments, the third communication can be same as a fifth communication transmitted by another AP. For example, the third communication can be the protection termination indication 540a (transmitted by the BS 104), which can be the same as the fifth communication, which can be the Protection termination indication 540b (transmitted by the BS 105). In various embodiments, the first time period includes a time of transmission of the third communication. For example, NAV 525a duration can protect transmission of the protection termination indication 540a

In various embodiments, transmission of the third communication can be synchronized with transmission from at least one other wireless device. For example, the third communication can be the protection termination indication 540a (transmitted by the BS 104), which can be transmitted synchronously with the fifth communication, which can be the Protection termination indication 540b (transmitted by the BS 105).

In various embodiments, the second communication can be the same as a fourth communication, transmitted simultaneously by another access point. For example, the second communication can be the C2S2 515a (transmitted by the BS 104), which can be transmitted synchronously with a fourth communication, which can be the C2S2 515b (transmitted by the BS 105).

In various embodiments, the method can further include transmitting one or more additional communications reserving access to the wireless medium during the LTE-U transmission. For example, BS 104 can transmit additional C2S1 505a communications, additional C2S2 515a communications, etc. In some embodiments, BS 104 can transmit additional C2S2 515a communications as discussed above with respect to FIG. 7.

In various embodiments, the additional communications reserve access to the wireless medium for overlapping time periods. For example, BS 104 can transmit WLAN protection indications 815, which can be configured to set overlapping NAVs 830. In various embodiments, the first wireless device includes a long term evolution unlicensed (LTE-U) device and the first and second communications include wireless local area network (WLAN) communications.

In various embodiments, the first wireless device includes an 802.11ax device and the first and second communications, and a third communication, include 802.11a communications. In various embodiments, the first communication includes a clear-to-send packet. In various embodiments, the second communication includes a clear-to-send packet.

In an embodiment, the method shown in FIG. 8 can be implemented in a wireless device that can include a generating circuit and a transmitting circuit. Those skilled in the art will appreciate that a wireless device can have more components than the simplified wireless device described herein. The wireless device described herein includes only those components useful for describing some prominent features of implementations within the scope of the claims.

The generating circuit can be configured to generate the first and second communications, and the LTE-U communication. In some embodiments, the generating circuit can be configured to perform at least blocks 910-930 of FIG. 8. The generating circuit can include one or more of processor 204 (FIG. 2), memory 206 (FIG. 2), and DSP 220 (FIG. 2). In some implementations, means for generating can include the generating circuit.

The transmitting circuit can be configured to transmit the first and second communications, and/or the LTE-U communication. In some embodiments, the transmitting circuit can be configured to perform at least blocks 910-930 of FIG. 8. The transmitting circuit can include one or more of transmitter 210 (FIG. 2), antenna 216 (FIG. 2), and transceiver 214 (FIG. 2). In some implementations, means for transmitting can include the transmitting circuit.

Referring again to FIG. 1, generally speaking, communication system 100 provides a significant advantage in terms of providing communication services to the users. Wireless communication system 100 extends the benefits of LTE Advanced for operating in the unlicensed spectrum while being in coexistence with operation of WLAN (i.e., WiFi) system. The combined operations of LTE-U and WLAN in wireless communication system 100 improves wireless data traffic for including more connected devices and richer communication content. The wireless communication for the WLAN is carried out based on the protocols provided in one or more of the 802.11 standards. The 802.11 standard generally includes features for the devices to “listen-before-talk” such that the devices could operate and use the communication resources (i.e., frequency and time) without denying access or causing potential interference to other devices in the same spectrum. The features associated with “listen-before-talk” allow a WLAN device to sense the communication medium and perhaps to transmit at a time where other devices are not using the same frequency channel. In various foregoing embodiments, LTE-U devices can be configured to transmit one or more WLAN signals that can naturally be received by a WLAN receiver at a lower power and/or larger range than a non-WLAN communication (e.g., the LTE-U communication). The one or more WLAN signals can include protection indications for subsequent WLAN signals and/or the non-WLAN signals, to provide greater guidance to LTE-U aware WLAN devices.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may include non-transitory computer readable medium (e.g., tangible media). In addition, in some aspects computer readable medium may include transitory computer readable medium (e.g., a signal). Combinations of the above should also be included within the scope of computer-readable media.

The methods disclosed herein include one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may include a computer program product for performing the operations presented herein. For example, such a computer program product may include a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of facilitating coexistence of wireless local area network (WLAN) devices and long term evolution unlicensed (LTE-U) devices in a communication network comprising a base station capable of both WLAN and LTE-U communication over a wireless medium, comprising:
transmitting, from a first wireless device, a first communication reserving access to the wireless medium during an indicated first time period, wherein the first communication comprises a contention-based transmission;
transmitting, during the first time period, a second communication reserving access to the wireless medium during an indicated second time period at least partially overlapping the first, wherein the second communication comprises a scheduled transmission; and
transmitting or receiving a long term evolution unlicensed (LTE-U) transmission during the second time period.

2. The method of claim 1, wherein the first time period includes a time of transmission of the LTE-U transmission.

3. The method of claim 1, further comprising transmitting, after the LTE-U transmission, a third communication canceling reservation of access to the wireless medium by the first and second communications, wherein the third communication comprises a scheduled transmission.

4. The method of claim 3, wherein the third communication comprises a contention-free period end frame.

5. The method of claim 3, wherein the third communication is same as a fifth communication transmitted by another AP.

6. The method of claim 3, wherein the first time period includes a time of transmission of the third communication.

7. The method of claim 3, wherein transmission of the third communication is synchronized with transmission from at least one other wireless device.

8. The method of claim 1, wherein the second communication is the same as a fourth communication, transmitted simultaneously by another access point.

9. The method of claim 1, further comprising transmitting one or more additional communications reserving access to the wireless medium during the LTE-U transmission.

10. The method of claim 9, wherein the additional communications reserve access to the wireless medium for overlapping time periods.

11. The method of claim 1, wherein the first wireless device comprises a long term evolution unlicensed (LTE-U) device and the first and second communications comprise wireless local area network (WLAN) communications.

12. The method of claim 1, wherein the first wireless device comprises an 802.11ax device and the first and second communications, and a third communication, comprise 802.11a communications.

13. The method of claim 1, wherein the first communication comprises a clear-to-send packet.

14. The method of claim 1, wherein the second communication comprises a clear-to-send packet.

15. An apparatus configured to facilitate coexistence of wireless local area network (WLAN) devices and long term evolution unlicensed (LTE-U) devices in a communication network comprising a base station capable of both WLAN and LTE-U communication over a wireless medium, comprising:
a processor configured to:
generate a first communication reserving access to the wireless medium during an indicated first time period, wherein the first communication comprises a contention-based transmission; and
generate, for transmission during the first time period, a second communication reserving access to the wireless medium during an indicated second time period at least partially overlapping the first, wherein the second communication comprises a scheduled transmission;
a first transmitter configured to transmit the first and second communications; and
a transmitter or receiver configured to transmit or receive a long term evolution unlicensed (LTE-U) transmission during the second time period.

16. The apparatus of claim 15, wherein the first time period includes a time of transmission of the LTE-U transmission.

17. The apparatus of claim 15, wherein the processor is further configured to generate, for transmission after the LTE-U transmission, a third communication canceling reservation of access to the wireless medium by the first and second communications, wherein the third communication comprises a scheduled transmission.

18. The apparatus of claim 17, wherein the third communication comprises a contention-free period end frame.

19. The apparatus of claim 17, wherein the third communication is same as a fifth communication transmitted by another AP.

20. The apparatus of claim 17, wherein the first time period includes a time of transmission of the third communication.

21. The apparatus of claim 17, wherein transmission of the third communication is synchronized with transmission from at least one other wireless device.

22. The apparatus of claim 15 wherein the second communication is the same as a fourth communication, transmitted simultaneously by another access point.

23. The apparatus of claim 15, wherein the processor is further configured to generate one or more additional communications reserving access to the wireless medium during the LTE-U transmission.

24. The apparatus of claim 23, wherein the additional communications reserve access to the wireless medium for overlapping time periods.

25. The apparatus of claim 15, wherein the apparatus comprises a long term evolution unlicensed (LTE-U) device and the first and second communications comprise wireless local area network (WLAN) communications.

26. The apparatus of claim 15, wherein the apparatus comprises an 802.11ax device and the first and second communications, and a third communication, comprise 802.11a communications.

27. The apparatus of claim 15, wherein the first communication comprises a clear-to-send packet.

28. The apparatus of claim 15, wherein the second communication comprises a clear-to-send packet.

29. An apparatus for facilitating coexistence of wireless local area network (WLAN) devices and long term evolution unlicensed (LTE-U) devices in a communication network comprising a base station capable of both WLAN and LTE-U communication over a wireless medium, comprising:
means for transmitting a first communication reserving access to the wireless medium during an indicated first time period, wherein the first communication comprises a contention-based transmission;
means for transmitting, during the first time period, a second communication reserving access to the wireless medium during an indicated second time period at least partially overlapping the first, wherein the second communication comprises a scheduled transmission; and
means for transmitting or receiving a long term evolution unlicensed (LTE-U) transmission during the second time period.

30. A non-transitory computer-readable medium comprising code that, when executed, causes an apparatus to perform a method of facilitating coexistence of wireless local area network (WLAN) devices and long term evolution unlicensed (LTE-U) devices in a communication network comprising a base station capable of both WLAN and LTE-U communication over a wireless medium, by:
transmit a first communication reserving access to the wireless medium during an indicated first time period, wherein the first communication comprises a contention-based transmission;
transmit, during the first time period, a second communication reserving access to the wireless medium during an indicated second time period at least partially overlapping the first, wherein the second communication comprises a scheduled transmission; and
transmit or receiving a long term evolution unlicensed (LTE-U) transmission during the second time period.
